(19) United States
(12) Patent Application Publication
(10) Pub. No.: US 2015/0248720 A1
(43) Pub. Date: Sep. 3, 2015

(54) RECOMMENDATION ENGINE

(71) Applicant: Stephen J. Brown, Woodside, CA (US)

(72) Inventor: Stephen J. Brown, Woodside, CA (US)

(73) Assignee: INVENT.LY LLC, Woodside, CA (US)

(21) Appl. No.: 14/195,335

(22) Filed: Mar. 3, 2014

(51) Int. Cl. G06Q 30/06

(52) U.S. Cl. CPC G06Q 30/0631

(57) ABSTRACT

A system and method that computes a probability score indicating the probability that the user would prefer a particular item. The system prompts the user to review a particular item and subsequently prompts the user to reveal whether he liked the item or otherwise. The search engine also extracts the other review scores which were generated by the reviewers in respect of the item name specified by the user. Subsequently, the search engine also elicits the other review scores, preferably along with the corresponding reviews, in respect of the items reviewed by the reviewers who also reviewed the item specified by the user. The system further calculates probability scores indicating the probability that a user would prefer any of the items related to the reviews generated by the reviewers who also reviewed the item specified by the user. Accordingly the system generates recommendations based on the probability scores.

### BACKGROUND

1. Technical Field

The embodiments herein generally relate to the field of information systems, and more particularly to a recommendation engine.

2. Description of the Related Art

With the advent of the information age, people, especially internet users are provided with access to an enormous set of information. The availability of a vast set of information not only provides a user with much needed information, but also increases the difficulty linked with zeroing in on the right set of information. Such a phenomenon, where information is available in plenty but the correct information is not readily accessible, is also referred to as information overloading.

Use of recommendation engines is one of the solutions for overcoming the issue of information overloading. A recommendation engine typically is a search engine that provides personalized recommendations to a user. A recommendation engine assists a user in finding relevant results in a personalized manner, i.e., based on a user's personal choices and preferences.

One of the preferred methods of generating recommendations is the statistical method, wherein behavioral aspects of a user and the statistics thereof are analyzed in detail and subsequently correlated to generate a recommendation. Prior art recommendation engines employ the statistical method and typically elicit a large spectrum of choices of information, analyzing which can indeed be overwhelming for a user. Due to the presence of overwhelming amounts of information, the user may end up ignoring the information he was actually searching for. However, if the user is diligent he may try and go through the available information and attempt to determine the necessary information. However, such a search would often be time consuming and may not result in an optimum result set. Often, the user would have to settle for less relevant information instead of taking into consideration all the presented information.

The aforementioned phenomenon is equally applicable for electronic media such as movies, wherein several movies are made available for public viewing every week, and wherein typical movie recommendation engines generate movie recommendations by analyzing users' behavior which is presumed based on the keywords provided by the user. A conventional movie recommendation engine also takes into consideration the genre related information linked with the movie logs which were previously accessed by the user in order to generate futuristic movie recommendations.

One of the drawbacks associated with conventional recommendation engines is that they can generate a movie recommendation corresponding to a user only after sufficient keywords and movie genre related information have been acquired from the user. To overcome the aforementioned drawback, some of the conventional recommendation engines attempt to generate movie recommendations despite the absence of operational logs (keywords and movie genre related information) corresponding to a user, by utilizing the movie related trends retrieved from the data corresponding to other like-minded users (who could be connected to the user in question on a social networking website). However, the quality of the recommendations may have been compromised given the fact that the movies are recommended solely based on the movie tastes related data gathered from people who are perceived to be having the same tastes as that of the user in question since they are connected with the user in question in one way or the other.

Moreover, some of the conventional recommendation engines depend completely upon the availability of sufficient operational logs (of the users) in order to be able to begin generating near accurate recommendations corresponding to the movies.

Further, some of the conventional recommendation engines make use of the user-user distance algorithm to provide recommendations to users. The user-user algorithm calculates the distance between the users, taking into consideration the ratings provided by the respective users with respect to a particular entity. For Example, if user ‘A’ and user ‘B’ have provided a five star rating to a particular movie, then the distance between them is zero. Some of the conventional recommendation engines make use of the distance between the individual users to generate recommendations. However, accurately computing the distances between a couple of users is always a tedious task given the possibility of the existence of minimal common traits. Moreover, in the case of movies, the ratings provided by a plurality of users would typically relate to those movies which have performed well in terms of revenue generation and viewers' responses. Therefore, generating a recommendation involving a movie which has not been termed as a blockbuster is difficult because of the lack of user ratings, which in turn affects the effective implementation of the user-user distance algorithm. Moreover, the conventional recommendation engines are expected to generate recommendations on the fly, and utilization of user-user distance algorithms, which involve determining the common traits amongst the users and analyzing the distance between the users, to generate recommendations, is a time consuming task in terms of the required analysis and computation.

Therefore, there is a need for a technique which can accurately and swiftly recommend movies based on the careful scrutiny of the tastes of individual users. There is also a need for a technique which can generate effective movie reviews despite the absence of operational logs. There is also a need for a technique that is capable of accurately correlating a user's tastes and preferences with the existing reviews, and recommends an item to the user based on the aforementioned correlation. There is also a need for a computer implemented system and method which encompass a low turnaround time in terms of generating accurate recommendations.

### SUMMARY

In view of the foregoing, the embodiments herein provide a computer implemented system for recommending at least one item to a user based at least partially on items previously reviewed by the user, the system comprising: a prompter that prompts the user to review at least one item, and prompts the user to assign a user score to the reviewed item based on a pre-determined user scoring criteria; a search engine that searches for and elicits a first group of at least one review score, the at least one review score generated by a respective at least one reviewer, wherein the first group of at least one review score corresponds with the item reviewed by the user, the search engine searching for and eliciting a second group of at least one review score, wherein the second group of at least one review score is generated by at least one reviewer who generated the first group of at least one review score; a processor that calculates weight scores based on a combination of the user score and each of the at least one review score available in the first group, the processor further linking the calculated weight scores with corresponding reviewers, the processor calculating an average weight corresponding to each the at least one reviewer based on respective weight scores, the processor calculating probability scores for each of the second group of at least one review score, the probability scores indicative of a probability of the user preferring each of the items corresponding to the at least one review score present in the second group, the probability scores being functions of respective at least one review score present in the second group and average weights of respective at least one reviewer; a recommendation engine that selects a review having a highest probability score and the item thereof from the second group, the recommendation engine recommending the selected item to the user; and a storage mechanism that stores information corresponding to at least one item previously recommended to the user, wherein the prompter selectively prompts the user to review at least one of the previously recommended items.

The storage mechanism stores information corresponding to a plurality of items including at least an item name, the first group of at least one review score, the second group of at least one review score, and information identifying the at least one reviewer thereof. The system further comprises a normalizer that normalizes: user scores based on a pre-determined normalization criteria; and the first group and second group of at least one review score based on the pre-determined normalization criteria. The processor calculates the weight scores using a function of squares of difference between each of the at least one review score in the first group and the user score.

The recommendation engine: sorts the items corresponding to the second group of at least one review score in a descending order based on corresponding probability scores; ranks the items corresponding to the second group of at least one review score based on respective probability scores; and generates a ranked item list. The system further comprises a data aggregation module that: extracts and aggregates user preference related information corresponding to user preferences from web based locations previously visited by the user; and transfers user preference related information to the recommendation engine. The recommendation engine selects and recommends at least one item corresponding to the second group of at least one review score to the user based at least partially on a combination of user preference related information and probability scores corresponding to each of the items in the second group of at least one review score.

The processor arranges the items and the corresponding reviewers in the form of a matrix; and performs a regression analysis to determine the weight scores to be linked with each of the at least reviewer. The prompter prompts the user to select an item for review from a pre-generated list; and the user to input a name of the at least one item to be reviewed. The system further comprises a clustering module that: groups a plurality of items into a plurality of pre-determined clusters based on reviews linked with each of the items, the clusters being arranged in the form of a list; and instructs the prompter to prompt the user to select and review the items present in the clusters.

Another embodiment provides a computer implemented method and program storage device for implementing the method of recommending at least one item to a user based at least partially on items previously reviewed by the user, the method comprising: prompting the user to review at least one item, and to assign a user score to the at least one reviewed item based on a pre-determined user scoring criteria; searching for and eliciting a first group of at least one review score that are generated by at least one reviewer and correspond to the item reviewed by the user; searching for and eliciting a second group of at least one review score that correspond to respective items, wherein the second group of at least one review score is generated by the at least one review who generated the first group of at least one review score; calculating weight scores corresponding to a combination of a user score and each of the at least one review score available in the first group, and linking the weight scores to corresponding reviewers; calculating average weights corresponding to each of the at least one reviewer based on the weight scores, and calculating probability scores for each of the second group of at least one review score, the probability scores indicative of a probability of the user preferring each of the at least one item present in the second group, the probability scores being functions of respective at least one review score present in the second group and average weights of respective at least one reviewer; selecting at least one review and the item thereof from the second group, the selected review comprising a highest probability score amongst the at least one review present in the second group; recommending the at least one selected item to the user; storing information corresponding to the at least one item previously recommended for review to the user; and selectively prompting the user to review at least one of the previously recommended at least one item.

The calculating of weight scores comprises calculating a weight score as a function of squares of difference between each of the at least one review score in the first group and the user score. The calculating of average weights corresponding to each of the at least one reviewer comprises normalizing user scores and each of the at least one reviewer score in accordance with a pre-determined normalization criteria. The prompting of the user to review at least one item comprises: prompting the user to select an item for review from a pre-generated list; and selectively prompting the user to input a name of the item to be reviewed.

The method may further comprise grouping a plurality of items into a plurality of pre-determined clusters based on the reviews linked with each of the items, the clusters being arranged in the form of a list; and instructing a prompter to prompt the user to select and review the items from the plurality of clusters. The calculating of the weight scores comprises arranging the items and corresponding reviewers in the form of a matrix and performing a regression analysis to determine the weight scores to be linked with each of the at least one reviewer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein and the objectives and advantages will be apparent by reading the following description in conjunction with the drawings in which:

FIG. 1A is a system level block diagram illustrating the functional blocks of a computer implemented system for recommending at least one item to a user in accordance with an embodiment herein;

FIG. 1B is block diagram of a user interface in accordance with an embodiment herein;

FIG. 1C is a matrix for calculating the average weight for each of the reviewers in accordance with an embodiment herein;

FIG. 1D is a matrix for calculating the probability score with respect to the second group of review scores in accordance with an embodiment herein;

FIG. 2 is a flow diagram illustrating the steps involved in a computer implemented method for recommending at least one item to a user in accordance with an embodiment herein; and

FIG. 3 illustrates a schematic diagram of a computer architecture used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

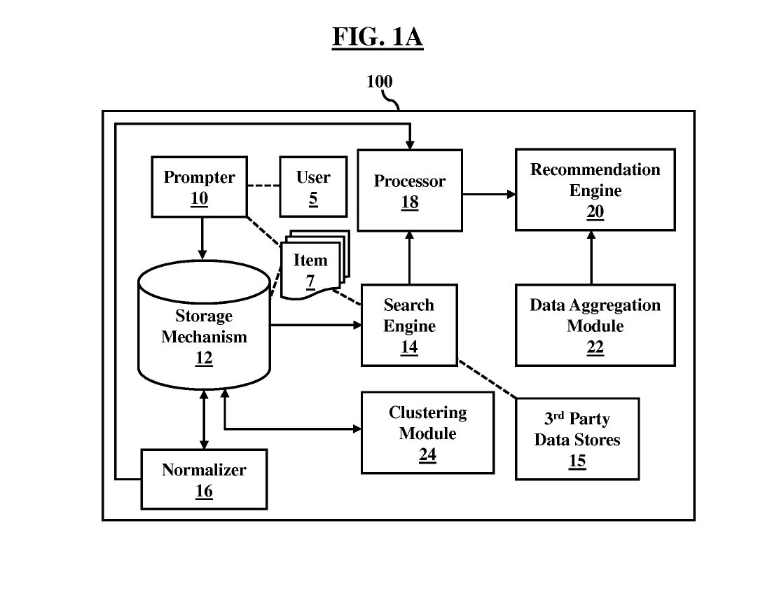

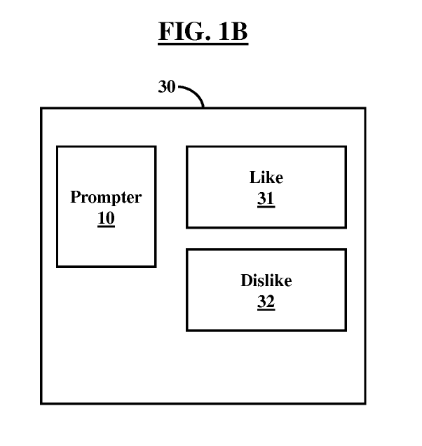

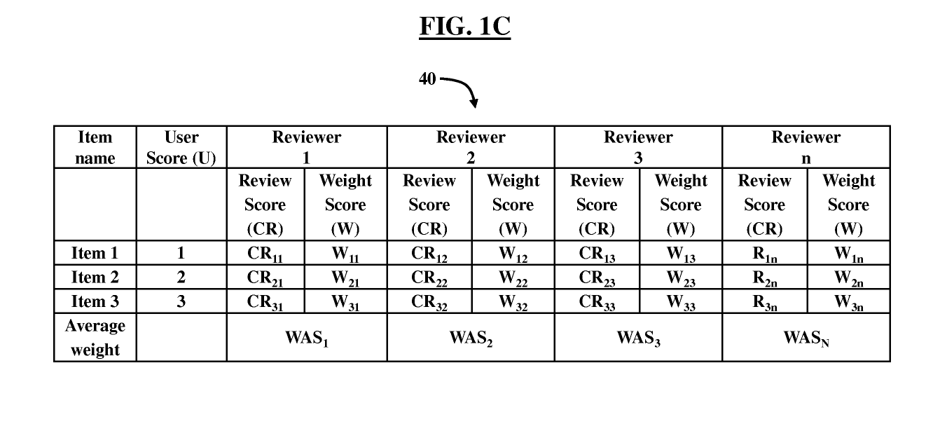

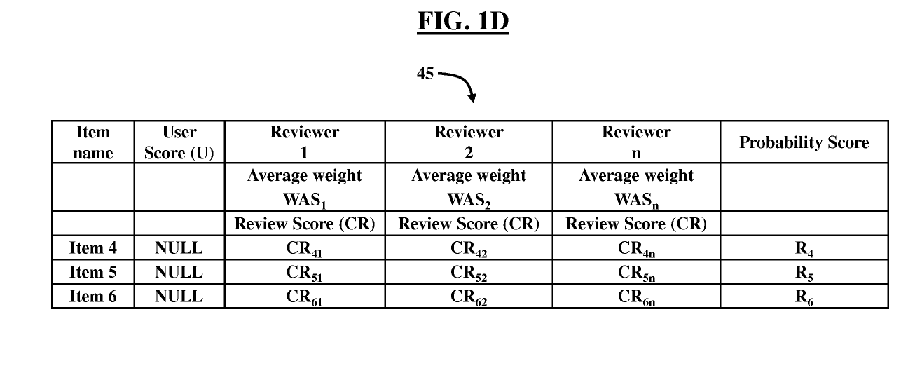

Referring now to the drawings, and more particularly to FIGS. 1A through 3, where similar reference characters denote corresponding features consistently throughout the figures, there are shown preferred embodiments.

Generating accurate recommendations, in-line with the preferences of a user is a daunting task. An effective recommendation engine should be able to generate accurate recommendations that closely correspond to the preferences and tastes of the user. Moreover, accurately determining the tastes and preferences of the user utilizing the available information is also a cumbersome task given the availability of voluminous information. The availability of voluminous information necessitates utilization of accurate data processing and analysis capabilities.

One of the methods utilized by conventional recommendation engines was to compute an intangible distance between a plurality of users by determining the preferences and tastes common to those users. Subsequently, the recommendation engine would generate recommendations based on the distance between the users. For example, if both user ‘A’ and user ‘B’ were to like a particular cuisine in a restaurant, then the distance between them with respect of that particular cuisine would be zero, and the recommendation engine, using this information would generate appropriate recommendations (wherein the recommendations would be similar to the cuisine liked by users ‘A’ and ‘B’) and provide them to either user ‘A’ or user ‘B’, depending upon who requests a recommendation. However, the methodology utilized by the conventional recommendation engines is not always accurate given the fact that there could exist very few or no commonalities between the users. The efficiency of the conventional recommendation engines is affected when there are no commonalities between the users. Owing to the lack of efficiency, conventional recommendation engines typically result in generating inaccurate recommendations, or recommendations which are not in-line with the tastes and preferences of the users.

Therefore, there was felt a need for a recommendation engine that provides accurate recommendations based on an accurate analysis of the tastes and preferences of the user. The recommendation engine takes into consideration the information corresponding to the tastes and preferences of the users and collaborates this information with the review related information obtained from the reviewers to ascertain the recommendations that would match the preferences and tastes of the user.

By employing the aforementioned mechanism, the recommendation engine performs an accurate mapping of the tastes and preferences of users and the reviewers. The recommendation engine works on the phenomenon that a user is more likely to accept a review from a reviewer whose tastes and preferences match with that of the user. For example, if a user ‘A’ prefers romantic movies, then it is highly likely that he would accept the reviews generated by a reviewer who is a connoisseur of action movies. Therefore, the recommendation engine generates recommendations in a manner where a user is recommended only those items which have been previously reviewed by reviewers having tastes and preferences similar to that of the user.

Further, by collaborating the user's tastes and preferences related information with the review related information, the recommendation engine obviates the need for employing the user-user distance algorithm, which may provide inaccurate results when no information corresponding to the distance between the users is available.

The recommendation engine provided by the embodiments herein obviates the need for comparing the tastes and preference related information elicited from different users, and generating recommendations based on the analysis of the resultant of aforementioned comparison. On the contrary, relying on the comparison of the tastes and preferences of users amongst one another would have rendered the recommendation engine ineffective, in the event of the availability of a limited number of users since there would be minimal information available for analysis and determination of a distance between the users. Furthermore, given the comparison between the ‘tastes & preferences related information’ of the users and the ‘review related information’ obtained from the reviewers, the recommendation provided by the embodiments herein also obviates the need for availability of common traits and preferences amongst the users, the absence of which would have rendered a conventional recommendation engine using the user-user distance algorithm, ineffective. The capabilities and functionalities of the recommendation engine provided by the embodiments herein are not affected by the number of users available, nor are they affected by the absence/scarcity of common tastes and preferences amongst the users.

FIG. 1A illustrates a computer implemented system 100 for recommending at least one item 7 to a user 5. The term ‘user’ as used herein refers to the people and/or mechanisms making use of the system 100. The term ‘item’ used herein refers to tradable products and/or services including but not restricted to movies, music compilations, books, restaurants, tourist places, land/air/sea transportation, and theater events, among other products and services. In FIG. 1A, a prompter 10 is configured to prompt the user 5 to enter the name of an item 4 through a user interface 30 of FIG. 1B.

The prompter 10 is typically equipped with auto filling-in capabilities, the use of which automatically completes the name of the item 7. Alternatively, the prompter 10 can also provide the user 5 with a pre-generated list, typically a drop down list of items, which includes the names of the items 7 which closely correspond to the letters input by the user 5, thereby enabling the user 5 to select the item 7 from the pre-generated list rather than manually entering the entire name of the item 7. The drop down list is pre-generated by the prompter 10 based on the keystrokes entered by the user 5. The list is further updated based on the keystrokes of the user 5. Alternatively, the pre-generated list can also include a listing of the most popular items which are frequently searched for by other users of the system 100.

The prompter 10 gathers information about the preferences and tastes of the user 5. Whenever the user 5 inputs the name of an item 7, subsequent to a prompt from the prompter 10, the name of the item 7 input by the user 5 is stored in the storage mechanism 12. Subsequently, the prompter 10 prompts the user 5 to review the item 7. The prompter 10 prompts the user 5 to specify whether he liked the item 7 or disliked the item 7. As shown in FIG. 1B, with reference to FIG. 1A, a user 5 can specify his liking or disliking for the entered item 7 by means for selecting a ‘Like’ response 31 or by means for selecting a ‘Dislike’ response 32 on a user interface 30. For example, the means for liking and disliking 31, 32 may be embodied as a ‘Like’ button or a ‘Dislike’ button, which are displayed on a user interface 30, providing access to the functions of the system 100. Alternatively, two radio buttons, one for expressing ‘Like’ and another for expressing ‘Dislike’ can also be displayed on the user interface 30. Alternatively, a drop down list involving two options namely ‘Like’ and ‘Dislike’ having the same functionalities as mentioned above can also be employed on the user interface 30. It is within the scope of the embodiments herein to employ any possible computer implemented methods for determining whether the user 5 liked a particular item or otherwise. For example, the user 5 could also be posed a question such as “did you like this item” and could be prompted to either click on a button reading ‘yes’ or a button reading ‘no’. Moreover, any subtle variations such as replacing the terms ‘like’ and ‘dislike’ with terms ‘loved it/hated it’, ‘yes/no’, ‘recommend/don't recommend’, and the like fall within the scope of the embodiments herein. Subsequently, the name of an item 7 input by the user 5 and the corresponding user score provided by the user 5 by means of either clicking the ‘like’ means 31 or the ‘dislike’ means 32 are stored in the storage mechanism 12 of FIG. 1A.

Again, with reference to FIG. 1A, the system 100 further includes a search engine 14. The search engine 14 receives the name of an item 7 entered/selected/input by the user 5 as the input and conducts a search across the storage mechanism 12 and optionally across certain third party data stores 15, including but not restricted to web servers storing reviews corresponding to products/services, to search for and elicit at least the review scores corresponding to the name of an item 7 input by the user 5. The search engine 14 performs a combination of pattern matching and one-to-one mapping to elicit the review scores corresponding to the name of an item 7 input by the user 5. The search engine 14 categorizes the elicited review scores into a first group of review scores. The first group of review scores includes those review scores that correspond to the name of an item 7 input by the user 5. Each of the review scores in the first group of review scores are linked to respective reviewers.

The search engine 14 further searches for the reviews and the review scores generated by the reviewers who also generated the first group of review scores. The search engine 14, in this case, implements a second mapping function, the use of which maps the reviewers linked with the first group of review scores with all the other reviews generated by each those reviewers. These reviews form a second group of review scores. The second group of review scores includes all those review scores generated by the reviewers who also generated the first group of review scores. As is apparent from the aforementioned description, the reviewers are in common in case of both the first group of review scores and the second group of review scores. The first group of review scores correspond to the name of an item 7 entered by the user 5, whereas the second group of review scores correspond to the items 7 which were not input by the user 5 during that particular iteration but generated by the same reviewers who generated the first group of review scores.

The review score could be arranged based on any numerical scale, for example ranging from ‘−10 to 10’ or ‘−5 to 5’ or ‘0 to 5’ and ‘0 to 10’, but with the understanding that the scores on the lower end of the rating scale (scores up to 4 on a scale of 10 for example) correspond to a negative review and that the scores on the upper end of the rating scale (scores in excess of 5 on a scale of 10) correspond to a positive review. The middle level score; i.e., score 5 in this case, corresponds to a neutral/average review score. The same numerical scale is also applicable for user scores. Furthermore, both the first group of review scores and the second group of review scores are normalized using a normalizer 16. The normalizer 16 adjusts the first and second group of review scores to a pre-determined scale wherein −1 corresponds to a negative review, 0 corresponds to a neutral review and +1 corresponds to a positive review. The detailed methodology of normalizing the values, which is a well-known feature, has been omitted for the sake of brevity. Further, it is within the scope of the embodiments herein to normalize and adjust the scores using any known statistical technique.

The system 100 further comprises a processor 18. The processor 18 receives, from the normalizer 16, the normalized first group and normalized second group of review scores. The processor 18 calculates the numerical difference between the ‘user score’ generated by the user 5 and each of the first group of review scores generated by respective reviewers for the item 7 under consideration. The numerical difference between the user score and each of the respective review scores (first group) is construed to be the distance (in terms of the opinion about the item 7 under consideration) between the user 5 and the respective reviewer. Subsequently, the processor 18 calculates a difference between the pre-determined ‘maximum possible distance’ and the absolute value of the difference between the user score and each of the review scores (first group) for the item under consideration, and subsequently squares up the resultant, to obtain a weight score. The weight score is subsequently assigned to the respective reviewer, with reference to the item 7 under consideration.

FIG. 1C denotes a matrix 40 generated by the system 100 for calculating the average weight corresponding to each of the reviewers. As shown in FIG. 1C, with reference to FIGS. 1A and 1B, Item 1, Item 2, and Item 3 are the items specified by the user 5 through the prompter 10. Subsequently, the user 5 assigns ‘user scores’ U₁, U₂, and U₃. The aforementioned information is stored in the storage mechanism 12 of FIG. 1A. Subsequently, the search engine 14 searches for the reviews (from reviewers) corresponding to the item(s) 7 specified by the user 5 and accordingly updates the matrix 40. Referring to FIG. 1C, ‘first group of review scores’ CR₁₁, CR₂₁, and CR₃₁ are specified by Reviewer 1 respectively for Item 1, Item 2, and Item 3. The review scores CR₁₂, CR₂₂, and CR₃₂ are specified by Reviewer 2 respectively for Item 1, Item 2, and Item 3. The review scores CR₁₃, CR₂₃, and CR₃₃ are specified by Reviewer 3 respectively for Item 1, Item 2, and Item 3.

Further, the processor 18 of FIG. 1A calculates the weight scores for every reviewer-item-user pair. For example weight score W₁₁ corresponds to Item 1 and Reviewer 1, whereas W₁₂ corresponds to Item 1 and Reviewer 2, and W₁₃ corresponds to Item 1 and Reviewer 3. The weight score for every item-reviewer-user pair is calculated by the rule Wₙₙ=(2−|CR₁₁−Uₙ|)². That is, to calculate W₁₁, the following rule will be utilized, W₁₁=(2−|CR₁₁−U₁|)². Similarly, to calculate W₁₂, the rule W₁₂=(2−|CR₁₂−U₁|)² would be utilized. Subsequently, the processor 18 calculates the weigh scores and updates the respective weight score fields of the matrix. Subsequently, the processor 18 calculates the cumulative weight (WAS) for each of the reviewers (e.g., Reviewers 1, 2, 3, . . . n) by utilizing the rule ‘WASₙ=average (Wₙₙ)’; i.e., for Reviewer 1, the average weight would be WAS₁=average (W₁₁, W₂₁, W₃₁); for Reviewer 2, the average weight would be WAS₂=average (W₁₂, W₂₂, W₃₂), etc.

The calculation of weight score involves analysis of a particular user-item-reviewer pair, in terms of the distance between the user 5 and reviewer in terms of the opinion about the item 7. In accordance with the embodiments herein, the reviewer having the highest average weight, in this case, either the reviewer having the score WAS₁ or the reviewer having the score WAS₂ or the reviewer having the score WAS₃ is deemed to have maximum impact on the thought process of the user 5, and the reviews by that particular reviewer would logically be given the highest priority and importance when it comes to generating recommendations for the user 5.

In accordance with the embodiments herein, every item (represented by the name of an item 7 or alternatively represented by an item identifier) input by the user 5 through the prompter 10 would be assigned a user score (−1 if the user dislikes the item; 0 if the user has a neutral opinion; and +1 if the user likes the item). Subsequently, the search engine 14 searches the storage mechanism 12 for the reviews corresponding to the item 7 (item name) input by the user 5. Subsequent to the relevant reviews being elicited by the search engine 14, the system 100 extracts the names of the reviewers who generated the respective reviews (reviews relating to the item specified by the user 5), and the corresponding review scores. Subsequently, the review scores are normalized by the normalizer 16 to the scale of −1 if the reviewer dislikes the item; 0 if the reviewer has a neutral opinion; and +1 if the reviewer likes the item. Subsequently, the processor 18 computes a weight score for the user-item-reviewer link. Subsequently the processor 18 calculates, for every reviewer, an average weight. The average weight for a reviewer is the average of all the weight scores assigned to the reviewer in respect of all the items (specified by the user 5).

Subsequently, the processor 18 arranges the user-item-reviewer pairs in decreasing order of average weights. A higher average weight (for a particular reviewer) indicates that the user 5 and the corresponding reviewer possess similar opinions in terms of the item(s) 7 specified by the user 5. Subsequently, a lower average weight (for a particular reviewer) indicates that the user 5 and the corresponding reviewer do not possess similar opinions, in terms of the item(s) 7 specified by the user 5. Therefore, when generating recommendations for a user 5 based on the available reviews and average weights, it is evident that the reviewer having a higher average weight should be given the priority considering the fact that the user 5 and the reviewer were of the same opinion with respect to a given item 7 and therefore there exists a possibility that the user 5 and the reviewer would have common tastes and preferences.

Subsequently, the processor 18 takes into consideration the second group of review scores elicited by the search engine 14, wherein the second group of review scores correspond to the review scores generated by the same reviewers who generated the first group of review scores (the first group of review scores corresponding to the item specified by the user 5).

The average weights (generated partly on the basis of the first group of review scores and subsequently assigned to the respective reviewers) indicate the probability that the user 5 and a reviewer are in-sync in terms of an opinion about a particular item 7. That is, a higher average weight (for a particular reviewer) indicates that the user 5 and the corresponding reviewer possess similar opinions, in terms of the item(s) 7 specified by the user 5. Subsequently, a lower average weight (for a particular reviewer) indicates that the user 5 and the corresponding reviewer do not possess similar opinions in terms of the item(s) 7 specified by the user 5. The system 100 instructs the search engine 14 to elicit the second group of review scores since the second group of review scores are generated by those reviewers who have already been assigned an average weight, and since there exists a possibility that the user 5 may like an item(s) 7 linked to the second group of review scores, since it could have been reviewed by a like-minded reviewer.

The processor 18 further calculates a probability score indicative of the probability that a user 5 may like a particular item 7, the item 7 having a review score which is a part of the second group of review scores. The processor 18, for every review score present in the second group, takes into consideration the respective average weight assigned to each of the reviewers and multiplies the same with the corresponding review score to arrive at a final score. Subsequently, the processor 18 computes an average of the final score and determines the probability score corresponding to a particular item that has been linked to a review score present in the second group of review scores.

FIG. 1D illustrates a matrix 45 for calculating the probability score with respect to the second group of review scores. As shown in FIG. 1D, with respect to FIGS. 1A through 1C, Item 4, Item 5, and Item 6 are the items which have been reviewed by the same reviewers who also reviewed the items specified previously by the user 5; i.e., Item 1, Item 2, and Item 3. It is to be noted that Items 4-6 do not have a user score since they have not been specified by the user 5. Items 4-6 are linked to the second group of review scores. The processor 18 calculates a probability that the user 5 prefers either of Item 4, Item 5, and Item 6. The processor 18 only takes the aforementioned items into consideration since these items have been reviewed by those reviewers who also reviewed the items previously specified by the user 5. It is to be noted that these items are not linked with a user score since these items have not been reviewed by the users but only by the reviewers. The average weights are extracted from matrix 40 by the processor 18. The average weights allocated to each of the reviewers indicates the proximity between the user 5 and the respective reviewer in terms of the opinion about the items. The processor 18, in the case of matrix 45, predicts the probability score corresponding to the probability that a user 5 would prefer a particular item which has been reviewed by a particular reviewer. To calculate R₄; i.e., the probability that the user 5 would prefer Item 4, the processor 18 makes use of the rule R₄=average (WAS₁*CR₄₁, WAS₂*CR₄₂ . . . WASₙ*CR₄ₙ) to determine the probability that the user 5 would prefer the Item 4. Simultaneously, the processor 18 calculates the probability scores for Item 5 and Item 6, using the aforementioned methodology accordingly updates the matrix 45.

The system 100 further includes a recommendation engine 20 cooperating with the processor 18 and configured to recommend the item 7 with the highest probability score (in this case, one amongst Item 4, Item 5, and Item 6), to the user 5. In accordance with the embodiments herein, the information corresponding to the items previously recommended to the user 5 are stored in the storage mechanism 12. The prompter 10 selectively prompts the user 5 to review the previously recommended items.

The system 100 further includes a data aggregation module 22 configured to extract and aggregate a user preference related information from ‘web based locations’ accessed by the user 5 by the way of using a web identity (typically a unique combination of a user name and password), and transfer the user preference related information to the recommendation engine 20 for further processing. The ‘web based locations’ include, but are not restricted to, the computer enabled resources (typically identified by unique universal resource locators) accessible through a computer network such as the World Wide Web. The recommendation engine 20 is configured to select at least one item from the second group of review scores, based on the combination of the user preference related information received from the data aggregation module 22 and the probability scores linked with each of the items linked to the second group of review scores.

The system 100 further comprises a clustering module 24 cooperating with the storage mechanism 12. The clustering module 24 groups a plurality of items 7 (items reviewed by users and the review information thereof being stored in the storage mechanism 12) into a plurality of pre-determined clusters based on the respective reviews. For example, the items 7 can be grouped based on whether they are associated with positive reviews, negative reviews and neutral reviews. Alternatively, the items 7 could be grouped based on the type of the item 7 (for example, product/service) and based on the nature of the item 7 (for example, a restaurant/a theatre event). The clustering module 24 typically arranges the clusters in the form of a list, displays the list and instructs the prompter 10 to prompt the user 5 to select and review the items 7 present in the clusters. The clustering module 24 enables the user 5 to either select one or more items 7 from a cluster for review, or to select an entire cluster and review the items 7 thereof.

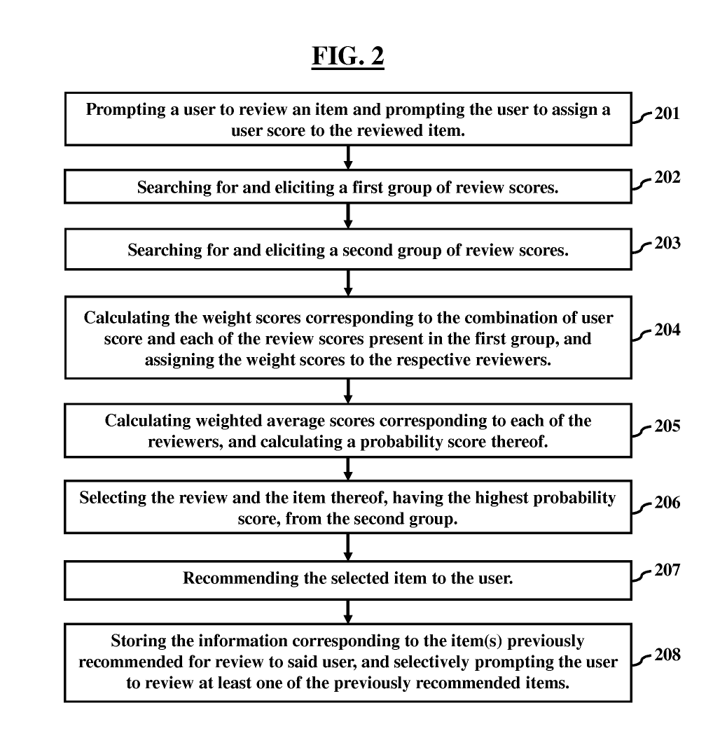

FIG. 2, with reference to FIGS. 1A through 1D, illustrates a flowchart illustrating a computer implemented method for recommending at least one item 7 to a user 5. The method comprises prompting (201) the user 5 to review at least one item 7, and prompting the user 5 to assign a user score to the reviewed item(s) 7 based on a pre-determined user scoring criteria; searching for and eliciting (202) a first group of review scores, wherein the first group of review scores are generated by reviewers and correspond to the item 7 reviewed by the user 5; searching for and eliciting (203) a second group of review scores, the second group of review scores corresponding to respective items 7, wherein the second group of review scores are generated by reviewer(s) who generated the first group of review scores; calculating (204) weight scores corresponding to the combination of the user score and each of the review score(s) available in the first group, and assigning the weight scores to the corresponding reviewers; calculating (205) average weights corresponding to each of the reviewers based on the weight scores assigned to each of the reviewers, and calculating the probability scores for each of the second group of review scores, the probability scores indicative of the probability of the user preferring each of the items present in the second group, the probability scores being functions of the respective review scores present in the second group and the average weight for the respective reviewers; selecting (206) at least one review and the item thereof from the second group, the review having the highest probability score amongst the reviews present in the second group of reviews; recommending (207) the selected item(s) to the user 5; and storing (208) the information corresponding to the item(s) previously recommended for review to the user 5, and selectively prompting the user 5 to review at least one of the previously recommended items.

The step (204) of calculating weight scores further includes the step of calculating the weight score as a function of squares of difference between each of the review scores in the first group and the user score. The step (205) of calculating average weights corresponding to each of the reviewers further includes the step of normalizing the user score and each of the reviewer scores in accordance with pre-determined normalization criteria. The step of prompting (201) the user 5 to review at least one item 7 further comprises prompting the user 5 to select an item 7 for review from a pre-generated list, and selectively prompting the user 5 to input the name of the item 7 to be reviewed.

The method may further comprise grouping a plurality of items 7 into a plurality of pre-determined clusters based on the reviews linked with each of the items 7, the clusters being arranged in the form of a list; and instructing a prompter 10 to prompt the user 5 to select and review the items 7 from the plurality of clusters. The step (204) of calculating the weight scores further includes the step of arranging the items 7 and the corresponding reviewers in the form of a matrix 40, 45 and performing a regression analysis to determine the weight scores to be linked with each of the reviewers.

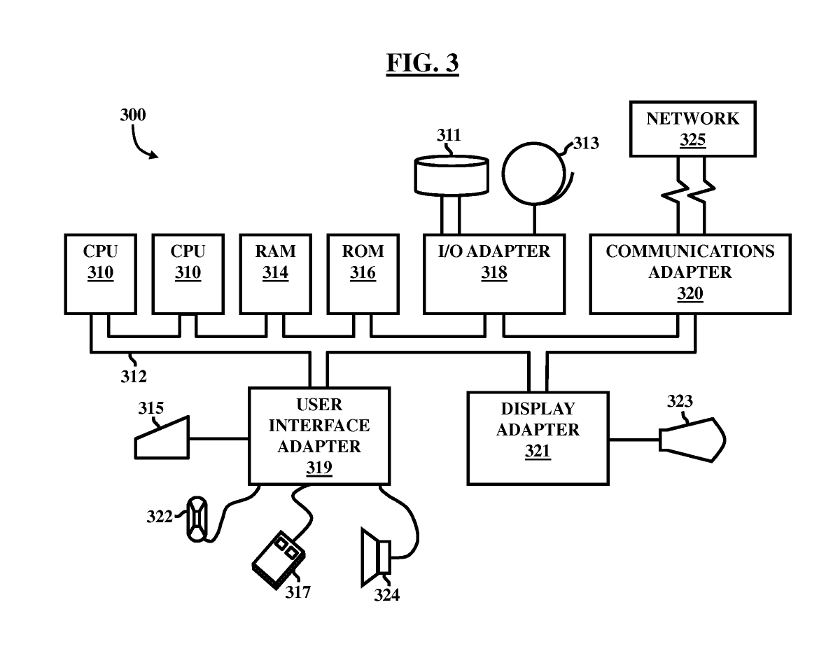

The embodiments herein further provide a non-transitory computer readable medium having computer readable instructions stored thereupon, the computer readable instructions when executed by a processor (e.g., CPU 310 of FIG. 3), cause a computer enabled device to prompt the user 5 to review at least one item 7, and prompt the user 5 to assign a user score to the reviewed item(s) 7 based on a pre-determined user scoring criteria; search for and eliciting a first group of review scores, wherein the first group of review scores are generated by reviewers and correspond to the item 7 reviewed by the user 5; search for and eliciting a second group of review scores, the second group of review scores corresponding to respective items 7, wherein the second group of review scores are generated by reviewer(s) who generated the first group of review scores; calculate weight scores corresponding to the combination of user score and each of the review score(s) available in the first group, and apply the weight scores to the corresponding reviewers; calculate average weight corresponding to each reviewer based on the weight scores assigned to each of the reviewers, and calculate the probability scores for each of the second group of review scores, the probability scores indicative of the probability of the user preferring each of the items present in the second group, the probability scores being functions of the respective review scores present in the second group and the average weight for the respective reviewers; select at least one review and the item thereof from the second group, the review having the highest probability score amongst the reviews present in the second group of reviews; recommend the selected item(s) to the user; store the information corresponding to the item(s) previously recommended for review to the user 5, and selectively prompt the user 5 to review at least one of the previously recommended items.

The computer readable instructions, when executed by a processor (e.g., CPU 310 of FIG. 3) further cause a computer enabled device to calculate the weight score as a function of squares of difference between each of the review scores in the first group and the user score; normalize the user score and each of the reviewer scores in accordance with a pre-determined normalization criteria; prompt the user 5 to select an item 7 for review from a pre-generated list; selectively prompt the user 5 to input the name of the item 7 to be reviewed; group a plurality of items 7 into a plurality of pre-determined clusters based on the reviews linked with each of the items 7, the clusters being arranged in the form of a list; instruct a prompter 10 to prompt the user 5 to select and review the items 7 from the plurality of clusters; and arrange the items 7 and the corresponding reviewers in the form of a matrix 40, 45 and performing a regression analysis to determine the weight scores to be linked with each of the reviewers.

The embodiments herein can include both hardware and software elements. The embodiments that are implemented in software include but are not limited to, firmware, resident software, microcode, etc. For example, the microcontroller can be configured to run software either stored locally or stored and run from a remote site.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

A representative hardware environment for practicing the software embodiments either locally or remotely is depicted in FIG. 3, with reference to FIGS. 1A through 2. This schematic drawing illustrates a hardware configuration of an information handling/computer system 300 in accordance with the embodiments herein. The system 300 comprises at least one processor or central processing unit (CPU) 310. The CPUs 310 are interconnected via system bus 312 to various devices such as a random access memory (RAM) 314, read-only memory (ROM) 316, and an input/output (I/O) adapter 318. The I/O adapter 318 can connect to peripheral devices 311, 313, or other program storage devices that are readable by the system 300. The system 300 can read the inventive instructions on the program storage devices and follow these instructions to execute the methodology of the embodiments herein. The system 300 further includes a user interface adapter 319 that connects a keyboard 315, mouse 317, speaker 324, microphone 322, and/or other user interface devices such as a touch screen device (not shown) to the bus 312 to gather user input. Additionally, a communication adapter 320 connects the bus 312 to a data processing network 325, and a display adapter 321 connects the bus 312 to a display device 323 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer implemented system for recommending at least one item to a user based at least partially on items previously reviewed by said user, the system comprising:
a prompter that prompts said user to review at least one item, and prompts said user to assign a user score to the reviewed item based on a pre-determined user scoring criteria;
a search engine that searches for and elicits a first group of at least one review score, the at least one review score generated by a respective at least one reviewer, wherein said first group of at least one review score corresponds with the item reviewed by said user, said search engine searching for and eliciting a second group of at least one review score, wherein said second group of at least one review score is generated by at least one reviewer who generated said first group of at least one review score;
a processor that calculates weight scores based on a combination of said user score and each of said at least one review score available in said first group, said processor further linking the calculated weight scores with corresponding reviewers, said processor calculating an average weight corresponding to each said at least one reviewer based on respective weight scores, said processor calculating probability scores for each of said second group of at least one review score, said probability scores indicative of a probability of said user preferring each of the items corresponding to said at least one review score present in said second group, said probability scores being functions of respective at least one review score present in said second group and average weights of respective at least one reviewer;
a recommendation engine that selects a review having a highest probability score and the item thereof from said second group, said recommendation engine recommending the selected item to said user; and
a storage mechanism that stores information corresponding to at least one item previously recommended to said user,
wherein said prompter selectively prompts said user to review at least one of the previously recommended items.

2. The system as claimed in claim 1, wherein said storage mechanism stores information corresponding to a plurality of items including at least an item name, said first group of at least one review score, said second group of at least one review score, and information identifying said at least one reviewer thereof.

3. The system as claimed in claim 1, further comprising a normalizer that normalizes:
user scores based on a pre-determined normalization criteria; and
the first group and second group of at least one review score based on said pre-determined normalization criteria.

4. The system as claimed in claim 1, wherein said processor calculates said weight scores using a function of squares of difference between each of said at least one review score in said first group and said user score.

5. The system as claimed in claim 1, wherein said recommendation engine:
sorts the items corresponding to said second group of at least one review score in a descending order based on corresponding probability scores;
ranks the items corresponding to said second group of at least one review score based on respective probability scores; and
generates a ranked item list.

6. The system as claimed in claim 1, further comprising a data aggregation module that:
extracts and aggregates user preference related information corresponding to user preferences from web based locations previously visited by said user; and
transfers user preference related information to said recommendation engine.

7. The system as claimed in claim 1, wherein said recommendation engine selects and recommends at least one item corresponding to said second group of at least one review score to said user based at least partially on a combination of user preference related information and probability scores corresponding to each of the items in said second group of at least one review score.

8. The system as claimed in claim 1, wherein said processor:
arranges the items and said corresponding reviewers in the form of a matrix; and
performs a regression analysis to determine the weight scores to be linked with each of said at least reviewer.

9. The system as claimed in claim 1, wherein said prompter prompts:
said user to select an item for review from a pre-generated list; and
said user to input a name of said at least one item to be reviewed.

10. The system as claimed in claim 1, further comprising a clustering module that:
groups a plurality of items into a plurality of pre-determined clusters based on reviews linked with each of the items, said clusters being arranged in the form of a list; and
instructs said prompter to prompt said user to select and review the items present in said clusters.

11. A computer implemented method of recommending at least one item to a user based at least partially on items previously reviewed by said user, said method comprising:
prompting said user to review at least one item, and to assign a user score to the at least one reviewed item based on a pre-determined user scoring criteria;
searching for and eliciting a first group of at least one review score that are generated by at least one reviewer and correspond to the item reviewed by said user;
searching for and eliciting a second group of at least one review score that correspond to respective items, wherein said second group of at least one review score is generated by said at least one review who generated said first group of at least one review score;
calculating weight scores corresponding to a combination of a user score and each of said at least one review score available in said first group, and linking said weight scores to corresponding reviewers;
calculating average weights corresponding to each of said at least one reviewer based on said weight scores, and calculating probability scores for each of said second group of at least one review score, said probability scores indicative of a probability of said user preferring each of said at least one item present in said second group, said probability scores being functions of respective at least one review score present in said second group and average weights of respective at least one reviewer;
selecting at least one review and said item thereof from said second group, the selected review comprising a highest probability score amongst said at least one review present in said second group;
recommending the at least one selected item to said user;
storing information corresponding to said at least one item previously recommended for review to said user; and
selectively prompting said user to review at least one of the previously recommended at least one item.

12. The method as claimed in claim 11, wherein the calculating of weight scores comprises calculating a weight score as a function of squares of difference between each of the at least one review score in said first group and said user score.

13. The method as claimed in claim 11, wherein the calculating of average weights corresponding to each of said at least one reviewer comprises normalizing user scores and each of said at least one reviewer score in accordance with a pre-determined normalization criteria.

14. The method as claimed in claim 11, wherein the prompting of said user to review at least one item comprises:
prompting said user to select an item for review from a pre-generated list; and
selectively prompting said user to input a name of the item to be reviewed.

15. The method as claimed in claim 11, further comprising:
grouping a plurality of items into a plurality of pre-determined clusters based on the reviews linked with each of the items, said clusters being arranged in the form of a list; and
instructing a prompter to prompt the user to select and review said items from said plurality of clusters.

16. The method as claimed in claim 11, wherein the calculating of the weight scores comprises arranging the items and corresponding reviewers in the form of a matrix and performing a regression analysis to determine said weight scores to be linked with each of said at least one reviewer.

17. A program storage device readable by computer, and comprising a program of instructions executable by said computer to perform a method for recommending at least one item to a user based at least partially on items previously reviewed by said user, said method comprising:
prompting said user to review at least one item, and to assign a user score to the at least one reviewed item based on a pre-determined user scoring criteria;
searching for and eliciting a first group of at least one review score that are generated by at least one reviewer and correspond to the item reviewed by said user;
searching for and eliciting a second group of at least one review score that correspond to respective items, wherein said second group of at least one review score is generated by said at least one review who generated said first group of at least one review score;
calculating weight scores corresponding to a combination of a user score and each of said at least one review score available in said first group, and linking said weight scores to corresponding reviewers;
calculating average weights corresponding to each of said at least one reviewer based on said weight scores, and calculating probability scores for each of said second group of at least one review score, said probability scores indicative of a probability of said user preferring each of said at least one item present in said second group, said probability scores being functions of respective at least one review score present in said second group and average weights of respective at least one reviewer;
selecting at least one review and said item thereof from said second group, the selected review comprising a highest probability score amongst said at least one review present in said second group;
recommending the at least one selected item to said user;
storing information corresponding to said at least one item previously recommended for review to said user; and
selectively prompting said user to review at least one of the previously recommended at least one item.

18. The program storage device as claimed in claim 17, wherein the calculating of weight scores comprises calculating a weight score as a function of squares of difference between each of the at least one review score in said first group and said user score.

19. The program storage device as claimed in claim 17, wherein the calculating of average weights corresponding to each of said at least one reviewer comprises normalizing user scores and each of said at least one reviewer score in accordance with a pre-determined normalization criteria.

20. The program storage device as claimed in claim 17, wherein the prompting of said user to review at least one item comprises:
prompting said user to select an item for review from a pre-generated list; and
selectively prompting said user to input a name of the item to be reviewed.

21. The program storage device as claimed in claim 17, wherein said method further comprises:
grouping a plurality of items into a plurality of pre-determined clusters based on the reviews linked with each of the items, said clusters being arranged in the form of a list; and
instructing a prompter to prompt the user to select and review said items from said plurality of clusters.

22. The program storage device as claimed in claim 17, wherein the calculating of the weight scores comprises arranging the items and corresponding reviewers in the form of a matrix and performing a regression analysis to determine said weight scores to be linked with each of said at least one reviewer.
